(19) United States
(12) Patent Application Publication
(10) Pub. No.: US 2026/0064744 A1
(43) Pub. Date: Mar. 5, 2026

(54) SYSTEM AND METHOD FOR PROVIDING HIGH-QUERY AI FOR USE WITH A DATA ANALYTICS ENVIRONMENT

(71) Applicant: ORACLE INTERNATIONAL CORPORATION, Redwood Shores, CA (US)

(72) Inventors: Nicholas Papano, Redmond, WA (US); Zachary Brown, Kansas City, MO (US); Madhvi Sharma, Seattle, WA (US); Suraj Bhat, Redmond, WA (US); Sandip Ghoshal, Dublin, CA (US); Santosh Kalki, Sammamish, WA (US)

(21) Appl. No.: 19/257,889

(22) Filed: Jul. 2, 2025

Related U.S. Application Data
(60) Provisional application No. 63/690,575, filed on Sep. 4, 2024.

(51) Int. Cl. G06F 16/334

(52) U.S. Cl. CPC G06F 16/3344; G06F 16/3347

(57) ABSTRACT

Embodiments described herein are generally related to data analytics environments, and are particularly directed to systems and methods for use with a data analytics environment to provide hi-query AI for use with the data analytics environment. Systems and methods disclosed can provide for query processing and semantic analysis. The system can take a user's natural language question and run a semantic search to discern the query's intent and find tables relevant to the question, and generate a query to run against a data store or data warehouse.

### CLAIM OF PRIORITY AND CROSS-REFERENCE TO RELATED APPLICATIONS

This application claims the benefit of priority to U.S. Provisional patent application titled “SYSTEM AND METHOD FOR PROVIDING HIGH-QUERY AI FOR USE WITH A DATA ANALYTICS ENVIRONMENT”, Application No. 63/690,575, filed Sep. 4, 2024; which above application and the contents thereof are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to data analytics environments, and are particularly directed to systems and methods for use with a data analytics environment to provide hi-query AI for use with the data analytics environment.

### BACKGROUND

Generally described, data analytics enables the computer-based examination of an amount of data, to derive an analytic data, metrics, conclusions, or other types of analytical information from, or descriptive of, the source data. Systems and methods can be used, for example, to generate an analytic business intelligence data, such as a set of data metrics or measures operating as key performance indicators, which analytically describe an organization's business-related data in a format useful to its decision-makers.

### SUMMARY

Embodiments described herein are generally related to data analytics environments, and are particularly directed to systems and methods for use with a data analytics environment to provide hi-query AI for use with the data analytics environment. Embodiments described herein are generally related to data analytics environments, and are particularly directed to systems and methods for use with a data analytics environment to provide hi-query AI for use with the data analytics environment. Systems and methods disclosed can provide for query processing and semantic analysis. The system can take a user's natural language question and run a semantic search to discern the query's intent and find tables relevant to the question, and generate a query to run against a data store or data warehouse.

In accordance with an embodiment, an exemplary method or use with a data analytics environment to provide hi-query AI for use with a data analytics environment can provide a computer including one or more processors, the computer provides access to a data analytics environment.

The method can provide an application running at the data analytics environment, wherein the application is configured to receive a natural language query from a client device. The method can, upon receiving the natural language query, communicate, by the application, a translation of the natural language query to a vector database. The method can provide, by the vector database to the application, one or more determined data tables or data columns as context for the query. The method can query, by the application, a determined large language model with the translation of the natural language query and the context provided by the vector database to receive a generated query. The method can run the generated query, by the application, against a data warehouse. The method can provide results of the generated query run against the data warehouse by the application to the client device.

### BRIEF DESCRIPTION OF THE DRAWINGS

FIG. 1 illustrates a system for providing a cloud infrastructure or data analytics environment, in accordance with an embodiment.

FIG. 2 further illustrates a system for providing a cloud infrastructure or data analytics environment, in accordance with an embodiment.

FIG. 3 illustrates an example use of the system to provide a data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 further illustrates an example data analytics environment, in accordance with an embodiment.

FIG. 8 further illustrates an example data analytics environment, in accordance with an embodiment.

FIG. 9 further illustrates an example data analytics environment, including the use of a large language model, in accordance with an embodiment.

FIG. 10 further illustrates an example data analytics environment, including the use of retrieval-augmented generation, in accordance with an embodiment.

FIG. 11 illustrates a system for providing hi-query AI for use with a data analytics environment, in accordance with an embodiment.

FIG. 12 illustrates a system for providing hi-query AI for use with a data analytics environment, in accordance with an embodiment.

FIG. 13 illustrates a system for providing hi-query AI for use with a data analytics environment, in accordance with an embodiment.

FIG. 14 illustrates a system for providing hi-query AI for use with a data analytics environment, in accordance with an embodiment.

FIG. 15 illustrates a screenshot produced by a system for use with a data analytics environment for providing hi-query AI for use with a data analytics environment, in accordance with an embodiment.

FIG. 16 illustrates a screenshot produced by a system for use with a data analytics environment for providing hi-query AI for use with a data analytics environment, in accordance with an embodiment.

FIG. 17 illustrates a screenshot produced by a system for use with a data analytics environment for providing hi-query AI for use with a data analytics environment, in accordance with an embodiment.

FIG. 18 illustrates a flowchart of a method for use with a data analytics environment to provide hi-query AI for use with a data analytics environment, in accordance with an embodiment.

### DETAILED DESCRIPTION

Generally described, within an organization, data analytics enables computer-based examination of large amounts of data, for example to derive conclusions or other information from the data. For example, business intelligence (BI) tools can be used to provide users with business intelligence describing their enterprise data, in a format that enables the users to make strategic business decisions.

Increasingly, data analytics can be provided within the context of enterprise software application environments, such as, for example, an Oracle Fusion Applications environment; or within the context of software-as-a-service (SaaS) or cloud environments, such as, for example, an Oracle Analytics Cloud or Oracle Cloud Infrastructure environment; or other types of analytics application or cloud environments.

Examples of data analytics environments and business intelligence tools/servers include Oracle Business Intelligence Server (OBIS), Oracle Analytics Cloud (OAC), and Fusion Analytics Warehouse (FAW), which support features such as data mining or analytics, and analytic applications.

### Cloud Infrastructure Environments

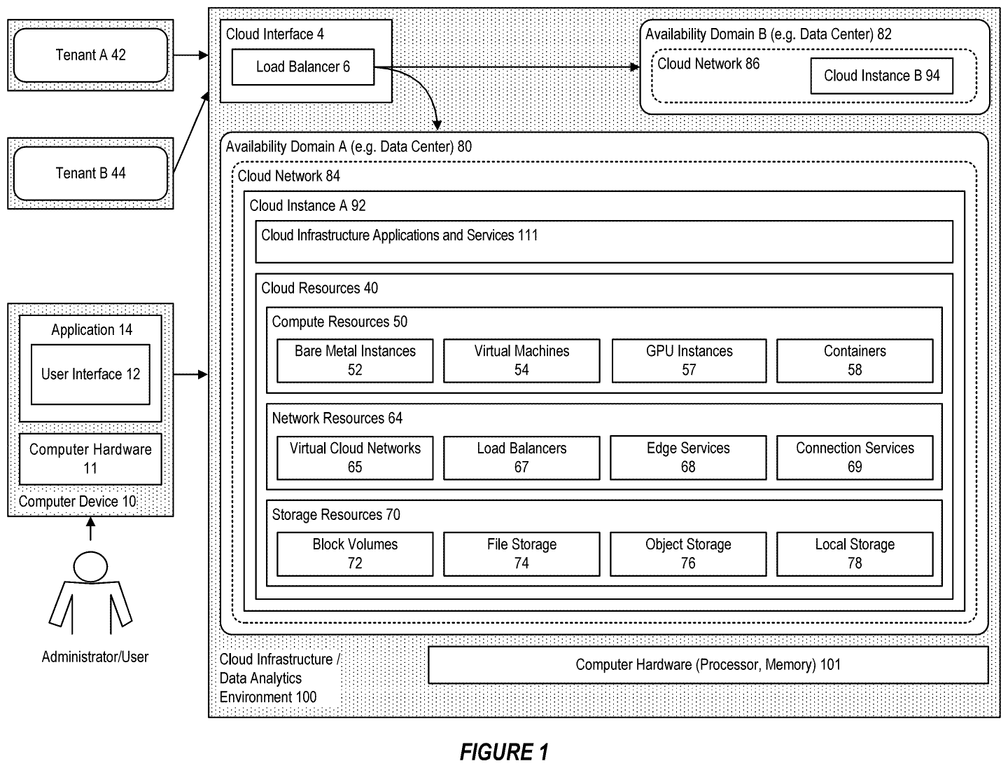

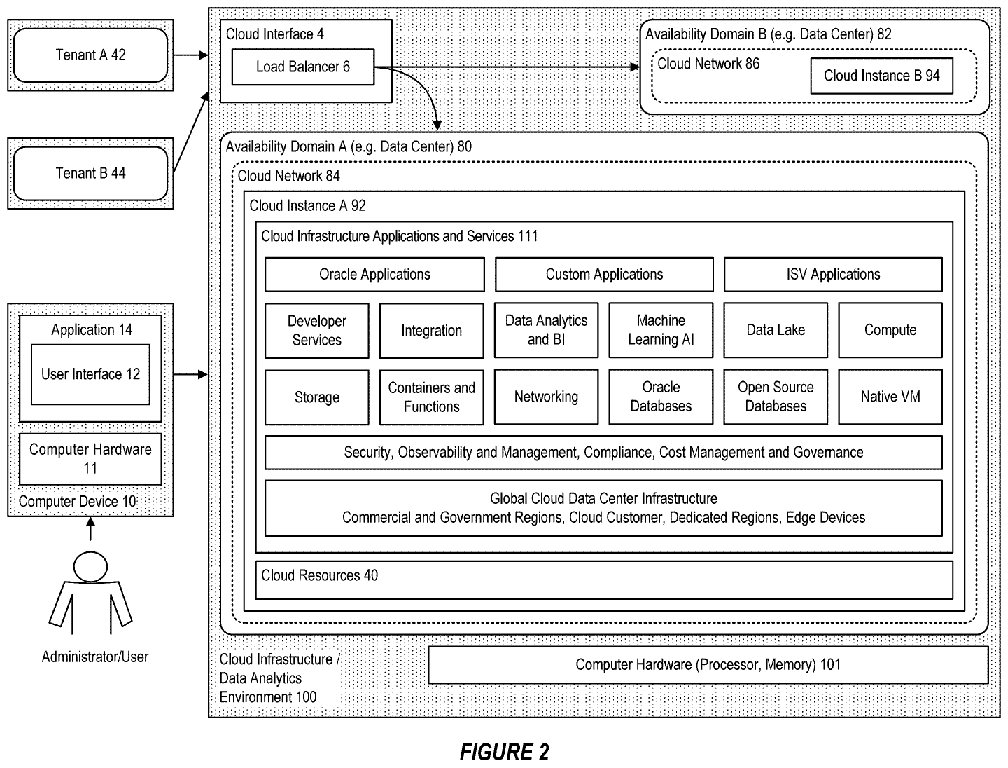

FIGS. 1 and 2 illustrate a system for providing a cloud infrastructure or data analytics environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system, or other suitably-programmed computer system.

The illustrated example is provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure or data analytics environment 100 can operate on a cloud computing infrastructure 101 comprising hardware (e.g., processor, memory), software resources, and one or more cloud interfaces 4 or other application program interfaces (API) that provide access to the shared cloud resources via one or more load balancers 6.

In accordance with an embodiment, the cloud infrastructure environment supports the use of availability domains, such as, for example, availability domains A 80, B 82, which enables customers to create and access cloud networks 84, 86, and run cloud instances A 92, B 94.

In accordance with an embodiment, a tenancy can be created for each cloud tenant/customer, for example tenant A 42, B 44, which provides a secure and isolated partition within the cloud infrastructure environment within which the customer can create, organize, and administer their cloud resources. A cloud tenant/customer can access an availability domain and a cloud network to access each of their cloud instances.

In accordance with an embodiment, a client device, such as, for example, a computing device 10 having a device hardware 11 (e.g., processor, memory), application 14 and graphical user interface 12, can enable an administrator other user to communicate with the cloud infrastructure environment via a network such as, for example, a wide area network, local area network, or the Internet, to create or update cloud services.

In accordance with an embodiment, the cloud infrastructure environment provides access to shared cloud resources 40 via, for example, a compute resources layer 50, a network resources layer 64, and/or a storage resources layer 70. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 52, virtual machines 54, graphical processing unit (GPU) compute cloud instances 57, and/or containers 58. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 65, load balancers 67, edge services 68, and/or connection services 69.

In accordance with an embodiment, the storage resources layer can comprise a number of resources, such as, for example, data/block volumes 72, file storage 74, object storage 76, and/or local storage 78.

In accordance with an embodiment, the cloud environment can include a container orchestration system, and container orchestration system API, that enables containerized application workflows to be deployed to a container orchestration environment, for example a Kubernetes (k8s) cluster.

For example, in accordance with an embodiment, the cloud environment can be used to provide containerized compute cloud instances within the compute resources layer, and a container orchestration implementation (e.g., Oracle Cloud Infrastructure Container Engine for Kubernetes (OKE)), can be used to build and launch containerized applications or cloud-native applications, specify compute resources that the containerized application requires, and provision the required compute resources.

As illustrated in FIG. 2, in accordance with an embodiment, the cloud infrastructure or data analytics environment can include a range of complementary cloud-based components, for example as cloud infrastructure applications and services 111, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

### Data Analytics Environments

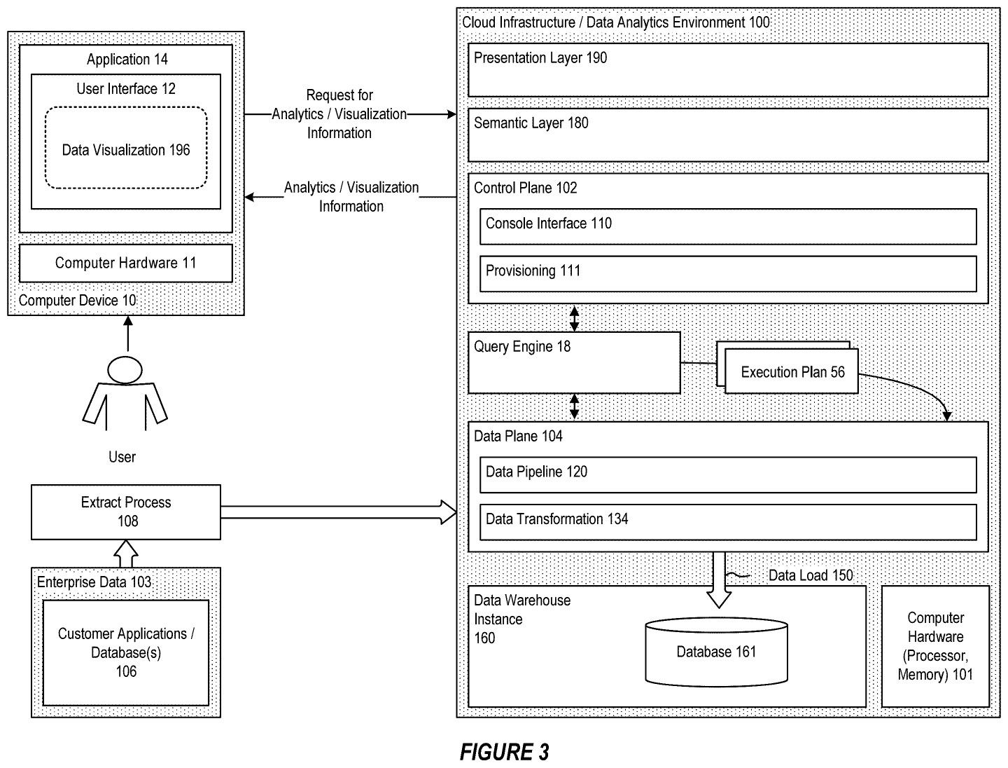

FIG. 3 illustrates an example use of the system to provide a data analytics environment, in accordance with an embodiment.

The example embodiment illustrated in FIG. 3 is provided for purposes of illustrating an example of a data analytics environment in association with which various embodiments described herein can be used. In accordance with other embodiments and examples, the approach described herein can be used with other types of data analytics, database, or data warehouse environments.

As illustrated in FIG. 3, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access in the manner of a data layer to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a customer (tenant) and/or a cloud environment having a provisioning component 111, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 120 and a data transformation layer 134, that together process data from an organization's enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization's enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract enterprise data 103 from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, analytics dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

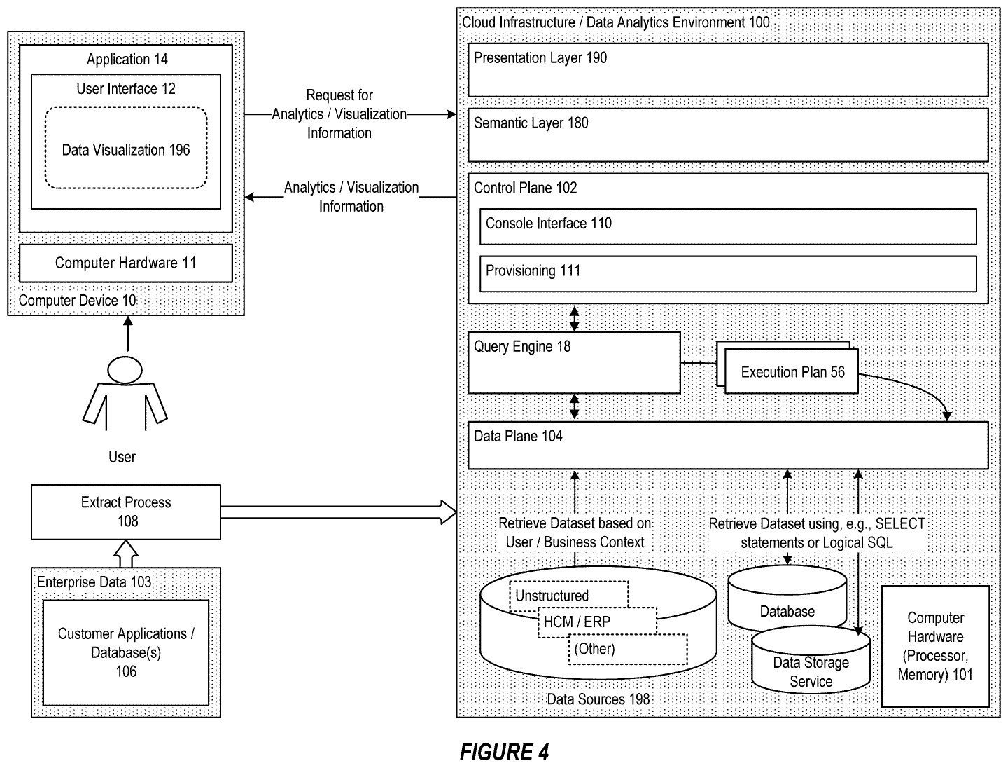

FIG. 4 further illustrates an example data analytics environment, in accordance with an embodiment.

As illustrated in FIG. 4, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), or Human Resources (HR), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

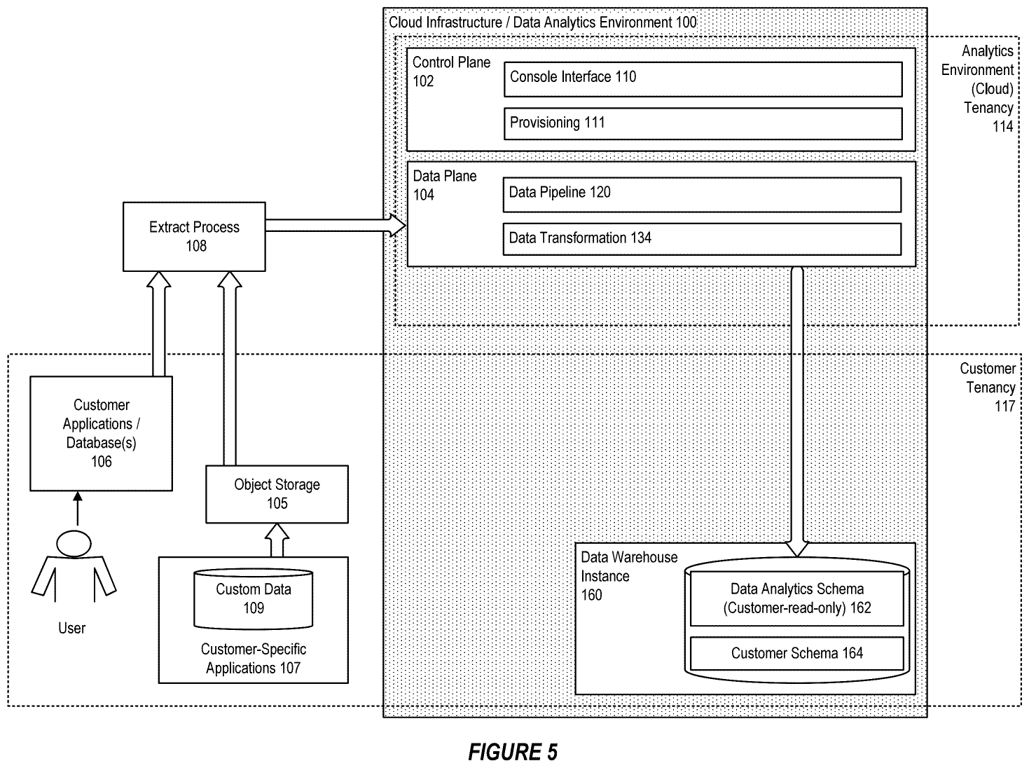

FIG. 5 further illustrates an example data analytics environment, in accordance with an embodiment.

As illustrated in FIG. 5, in accordance with an embodiment, data can be sourced, e.g., from a customer's (tenant's) enterprise software environment (106), using the data pipeline process; or as custom data 109 sourced from one or more customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each customer (tenant) of the system, a customer schema 164. For each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

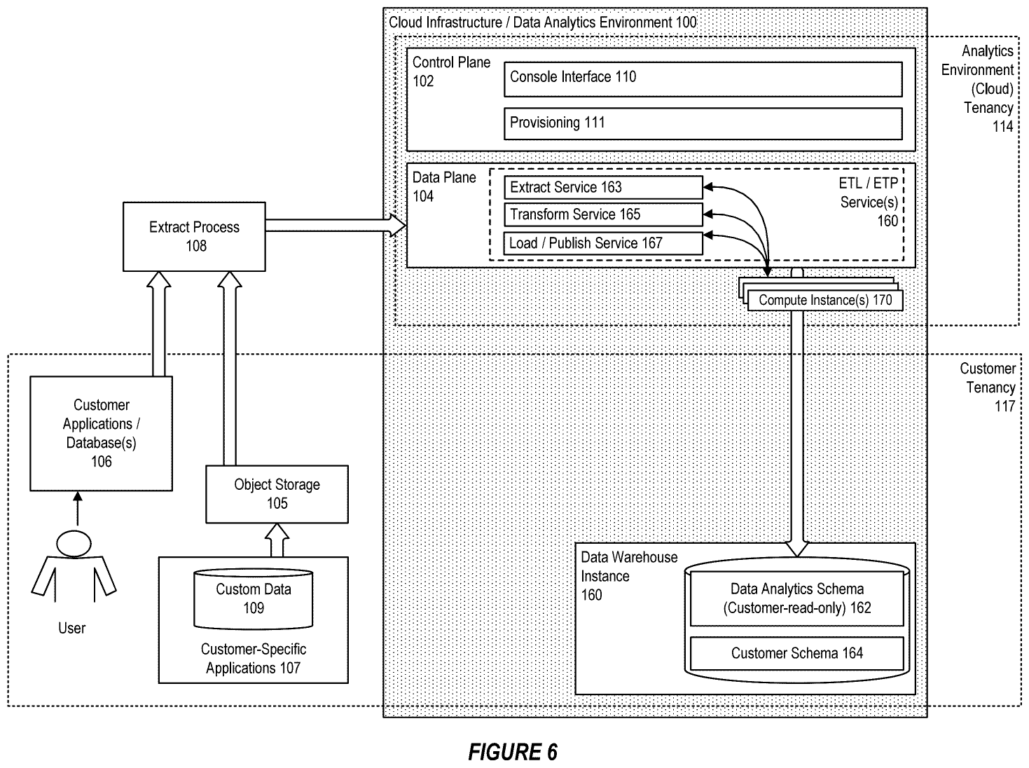

FIG. 6 further illustrates an example data analytics environment, in accordance with an embodiment.

As illustrated in FIG. 6, in accordance with an embodiment, the process of extracting data from a customer's (tenant's) enterprise software environment, and loading the data to a data warehouse instance, or refreshing the data in a data warehouse, generally involves several stages, performed by an ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

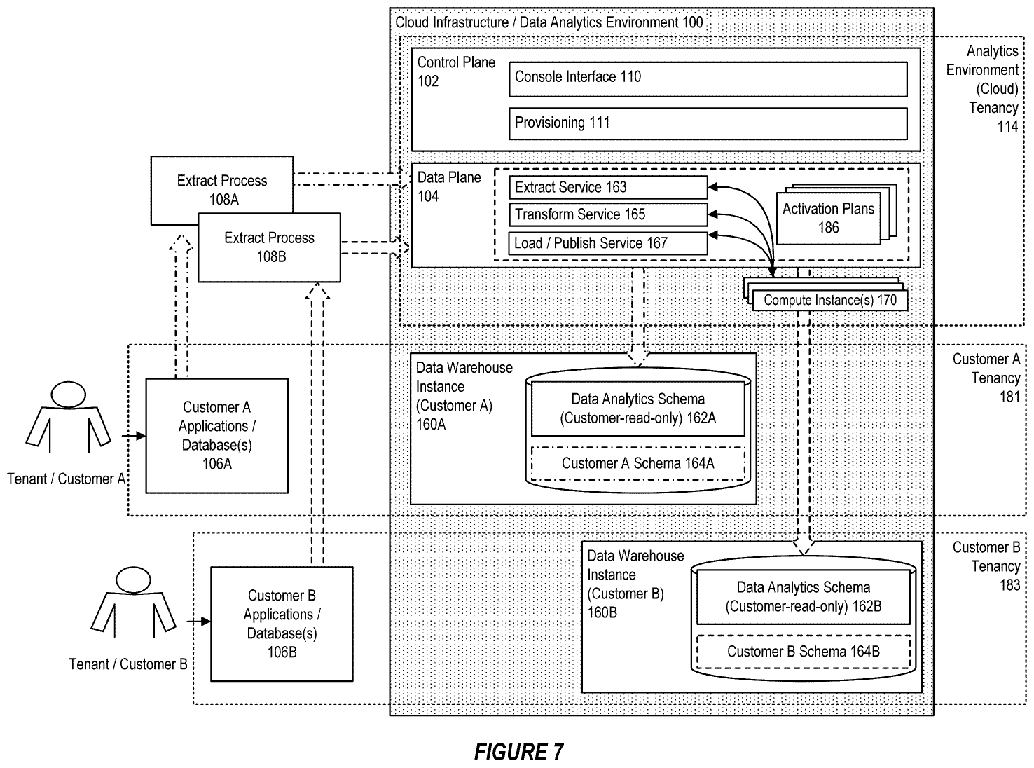

FIG. 7 further illustrates an example data analytics environment, in accordance with an embodiment.

As illustrated in FIG. 7, in accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case. For each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs. For example, an activation plan can define a number of extract, transform, and load (publish) services or steps to be run in a certain order, at a certain time of day, and within a certain window of time.

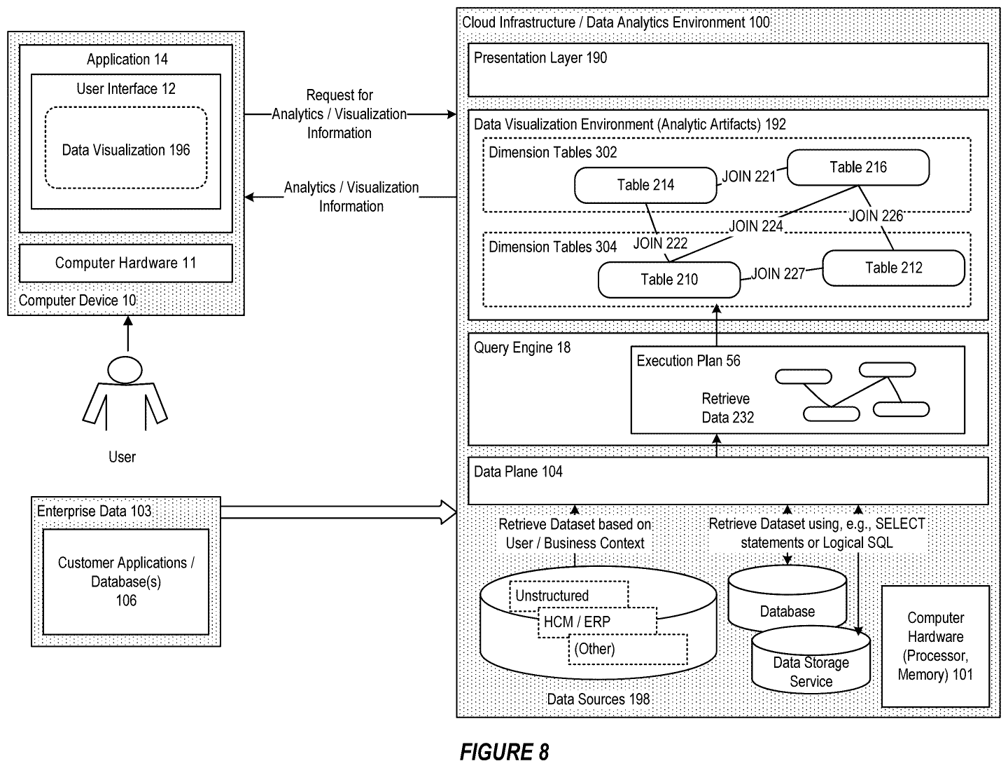

FIG. 8 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 8, in accordance with an embodiment, the data analytics environment enables a dataset to be retrieved, received, or prepared from one or more data source(s), for example via one or more data source connections, fact and/or dimension tables 210, 212, 214, 216, or joins 221, 222, 224, 226, 227 between selections of dimension tables 302, 304.

In accordance with an embodiment, a request received at a data visualization environment to display analytic artifacts 192, for example as may be related to key performance indicators, analytics dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Large Language Models (LLM)

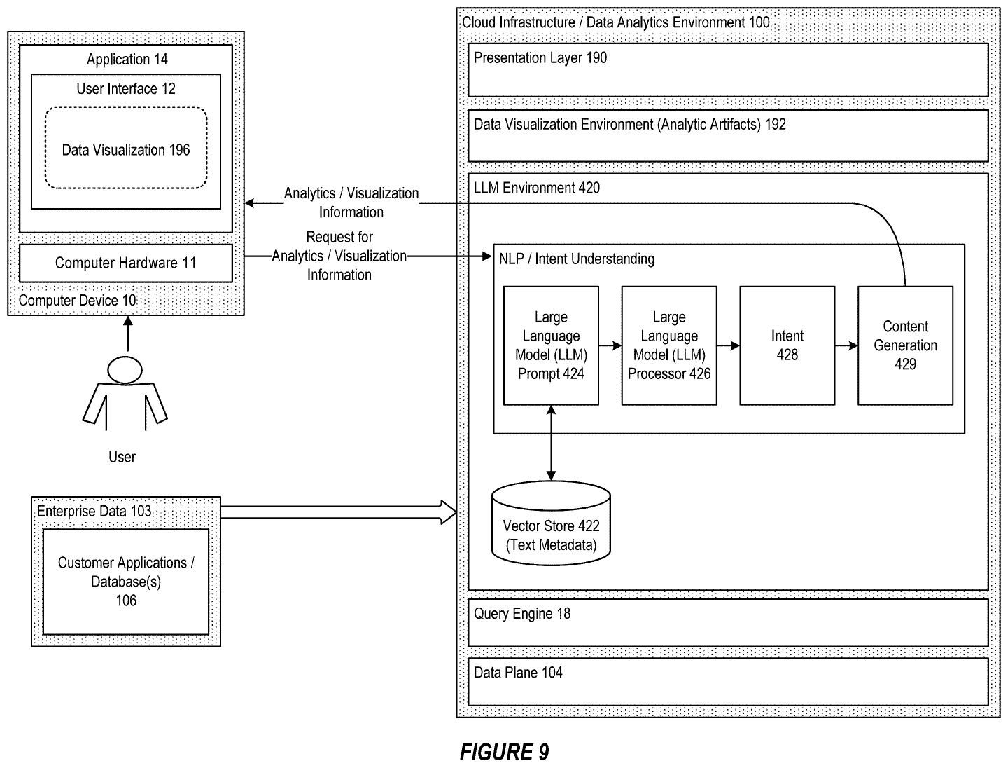

FIG. 9 further illustrates an example data analytics environment, including the use of a large language model, in accordance with an embodiment.

As illustrated in FIG. 9, in accordance with an embodiment, a data analytics system can include a large language model (LLM) environment 420. A vector database 422 provides storage and retrieval of vectors or vector embeddings, which in turn enables LLMs to understand information with increased context and accuracy, for example in generating a requested data analytics information or data visualization.

In accordance with an embodiment, the system can parse a user query or natural language input, infer an intent 428 based on one or more large language model (LLM) prompt 424 or LLM processor 426, and then determine, for example, which subject areas may be relevant to the inferred intent, and generate or return an appropriate content 429.

### Retrieval-Augmented Generation (RAG)

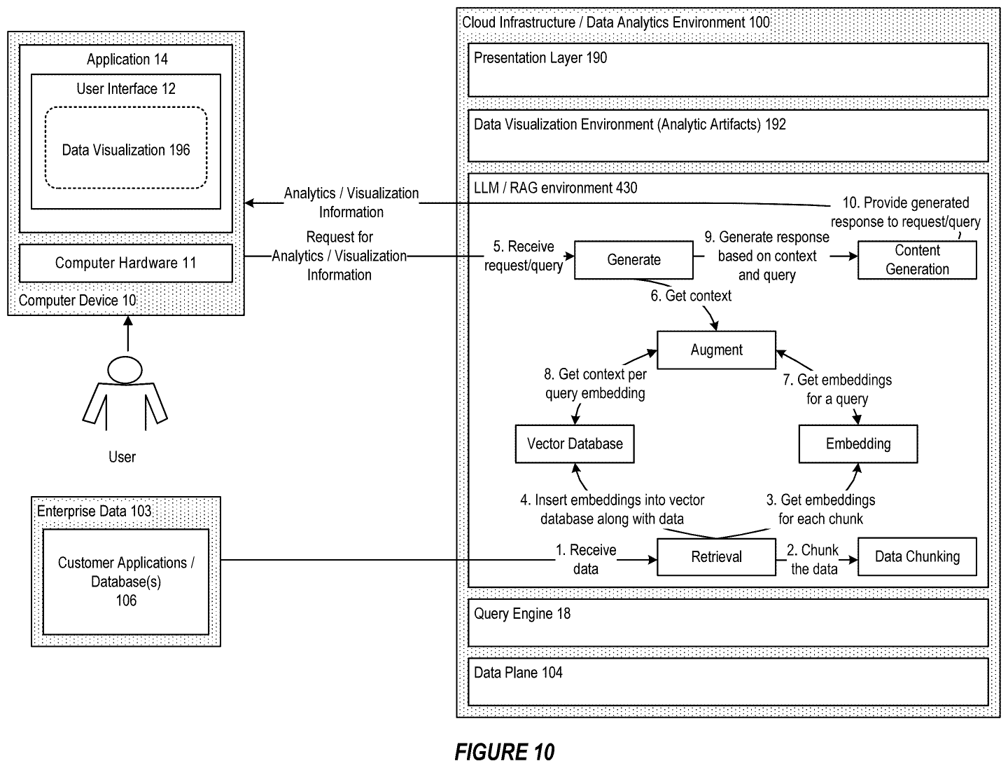

FIG. 10 further illustrates an example data analytics environment, including the use of retrieval-augmented generation, in accordance with an embodiment.

As illustrated in FIG. 10, in accordance with an embodiment, a data analytics system can include the use of retrieval-augmented generation (RAG) environment 430 that optimizes the output of a large language model (LLM) with targeted information, to provide a more contextually appropriate content in response to a user query.

In accordance with an embodiment, during the retrieval process:

Enterprise data can be received (1) in various formats, for example, as PDF, TXT, CSV, XML, or JSON documents, via REST, File, or other protocols.

The enterprise data or documents is broken into a plurality of segment or chunks (2).

Vector embeddings are obtained for each chunk of data (3), for example by calling a generative AI embedding service, or by using an embedding model.

The vector embeddings associated with the chunks of data are stored in a vector database, along with the data (4).

In accordance with an embodiment, during the augmented generation process:

The system can receive from a user, a data request or query, or a natural language input (5).

The system invokes an augmentation process or service to obtain the context for the request or query (6).

An embedding service is used to get the vector embeddings of the query data (7).

The augmentation process or service can obtain additional context based on a semantic search of the query data and its vector embedding (8).

The system can then generate an appropriate response based on the context and query (9); and return the generated response to the user (10).

The above example is provided for purpose of illustrating an example of a data analytics environment that includes the use of retrieval-augmented generation. In accordance with other embodiments, the system can include other forms of retrieval-augmented generation, which in turn can include different or other components or processes.

HI-Query AI for Use with a Data Analytics Environment

Querying and accessing insights from large and complex databases can require a deep understanding of coding and query engineering, such as SQL coding and engineering, which places a significant barrier for non-technical stakeholders. Such barriers are present in several settings, including healthcare. Current solutions require engineers to write each query, which can add days or weeks of delay per request, in turn making scaling near impossible. This presently disclosed systems and methods drastically lower this barrier, making data-driven insights and measures accessible to a broader audience in a faction of the time.

Currently available methods for authoring and management on systems is a manual and time intensive process. Algorithms on the platform are written in proprietary coding language and require that engineers write this content and manage all algorithms for all customers on the platform. The process for delivering algorithm requirements to engineering is extensive and includes several handoffs between teams. The net result of this arrangement have turnaround times for algorithm updates that are excessively long, charging large amounts for customizations that customers should be able to make themselves, and poor quality due to multiple handoffs and interpretations of requirements. Users experience the consequences of this process by ultimately not realizing the full value of the investments they've made in data analytics environments and by being unable to unlock the full ability to measure quality and drive meaningful care interventions via such platforms. In addition, the current systems and methods can be limited in the number of standard quality measure catalogs that can be provided to clients to drive additional insights, value, and regulatory reporting capabilities. These are critical metrics clients, such as healthcare entitles, use to receive funding, and therefore these pain points are a very high priority for clients.

Large databases present issues for data queries. For example, a typical healthcare database can encompass over 400 tables, each with tens or hundreds of columns, and terabytes in size per customer. This, partnered with varying degrees of descriptive clarity in column names and complex table relationships, presents unique challenges. The sheer volume and technical nature of the data, coupled with the nuanced domain of medical analytics, make intuitive data access a formidable task. This complexity is the reason engineers write queries for clients.

In accordance with an embodiment, the systems and methods can utilize a large language model (LLM) with retrieval augmented generation (RAG) connected to the analytics systems on the backend. Such systems and methods can translate a client/user's input into an executable database query, execute the database query, then return the results along with an interpretation of the data. The RAG system can query various vector, graph, and SQL databases to add context to the prompt to answer the user question. To avoid large latencies with multiple LLM calls, a library of commonly used measures and a set of commonly asked questions can be provided. At the front end, a chat interface can be provided, with access to chat history and back-and-forth discussions with the LLM. This is all focused around providing an intelligent agent that can answer a wide variety of questions and greatly simplify the measure building process. By providing a natural language interface to the database, the turnaround time for writing measures can be greatly reduced.

Currently, clients/users do not write queries and measures due to the overwhelming complexity and proprietary nature of the database systems. The process includes submitting tickets to get queries written, going through a cycle or cycles of running and debugging measures with the client, and it passes through many product and engineering teams during this time. The described systems and methods can replace this process, greatly simplifying the experience and putting the measure writing process directly in the hands of the client/user. This can greatly reduce the cost and time required to create measures. This reduction allows clients to spend more time acting on the insights and less time waiting for them.

Measure writing is a non-trivial task. A healthcare measure can comprise a tool used to quantify or evaluate aspects of healthcare processes, outcomes, patient perceptions, and organizational structures that contribute to high-quality care. These measures help assess and improve different areas of healthcare, including clinical processes, patient safety, and overall patient experience. Even simple measures require both domain knowledge and database knowledge to write, run, and analyze. Due to the number of concepts stored into thousands of columns, all current measure writing processes require a lot of intermediate human intervention, either by engineers pre-preparing a library of commonly used measures or writing new ones as requirements change. A naïve approach of stuffing all relevant information to write a measure into the context window fails because this greatly exceeds the window size of LLMs.

In accordance with an embodiment, by enriching the LLM's prompt with the exact relevant domain information and the intricacies of target database systems based on the user query, nearly all steps of the measure creation process can be done by the system, and the user only needs to describe the measure they want or need. The systems and methods described herein provide a fully automated measure creation process.

In accordance with an embodiment, the systems and methods provide for query processing and semantic analysis. The system can take a user's natural language question and run a semantic search to discern the query's intent and find tables relevant to the question.

In accordance with an embodiment, the systems and methods provide for query, such as SQL, generation and execution: The large language model (LLM) takes the context dynamically generates optimized queries (e.g., SQL queries), executing them to retrieve data from a database, such as a health analytics database.

In accordance with an embodiment, the systems and methods return generated query (e.g., SQL) and data: The system can then return the exact query (e.g., SQL) run and provide a file of the actual data retrieved to provide to the user/client, or provide a link or file by which the user/client can download the retrieved data.

In accordance with an embodiment, the systems and methods described herein can be utilized with additional, complex databases and domains. The systems and methods can: utilize a two-stage RAG system (e.g., adding a re-ranker to process the vector DB's output); creating visualizations by sending queries/results to an analytics platform or program (e.g., Oracle Analytics Cloud); fine-tuning a custom LLM on dataset of related natural language queries (e.g., such as healthcare natural language queries) generate queries (e.g., SQL queries); expanding to all Longitudinal record database tables (and supplementary tables); providing safety around LLM-generated SQL via permissions and hooking LLM directly up to tools that create prepared statements; thoroughly evaluating LLM models, configurations and prompt engineering techniques for the best performance; and generalize the RAG part of the system to work with other health analytics data and solutions such as a chatbot to allow customers to chat with help documentation.

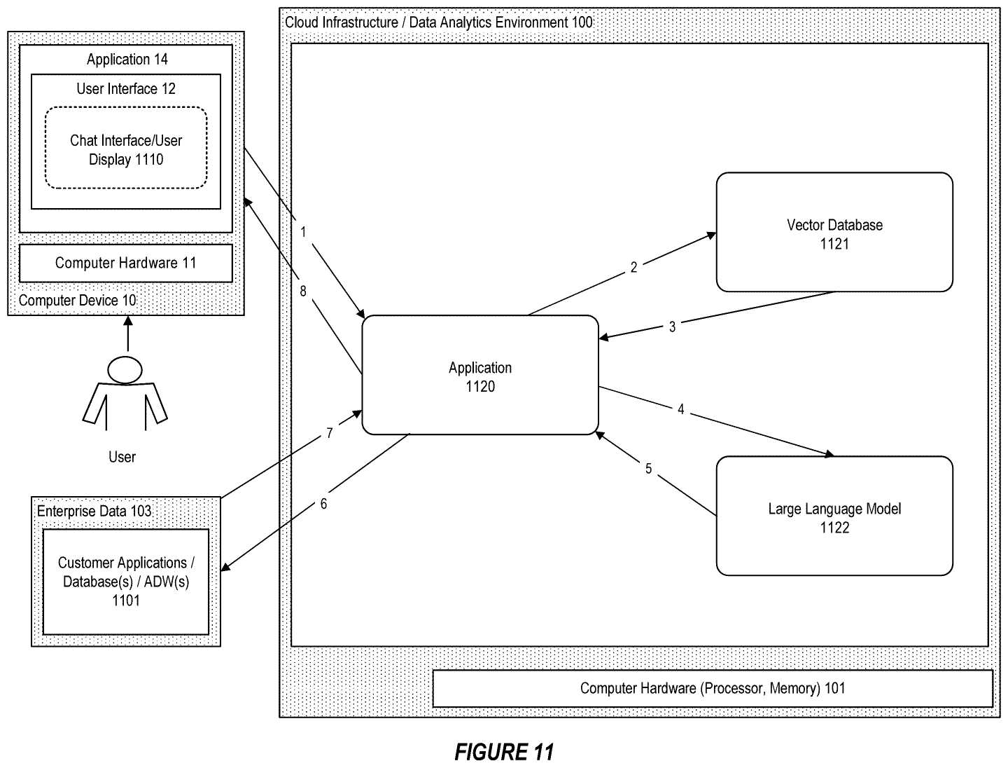

FIG. 11 illustrates a system for providing hi-query AI for use with a data analytics environment, in accordance with an embodiment.

In accordance with an embodiment, a cloud infrastructure or data analytics environment 100 can operate on a cloud computing infrastructure 101 comprising hardware (e.g., processor, memory), software resources, and one or more cloud interfaces or other application program interfaces (API) that provide access to the shared cloud resources via one or more load balancers.

In accordance with an embodiment, a client device, such as, for example, a computing device 10 having a device hardware 11 (e.g., processor, memory), application 14 and user interface 12, such as a graphical user interface, can enable an administrator other user to communicate with the cloud infrastructure environment via a network such as, for example, a wide area network, local area network, or the Internet, to create, utilize or update cloud services.

In accordance with an embodiment, an application 1120 can be provided within the cloud infrastructure/data analytics environment 100. The application, which when accessed by, for example, the computer device 100 can provide at the user interface, a chat or text interface 1110 which a user can interact with and/or provide inputs or receive outputs from.

In accordance with an embodiment, the application, at 1, can receive a request for a query from the computer device. The request can comprise, for example, metrics sought by a user of the client device, and/or a measure. The request can comprise a natural language request. The system can take a user's natural language question and run a semantic search to discern the query's intent and find tables relevant to the question. Example requests can comprise, “What are the top 5 most common appointment types?”, or “What percentage of patients under 5 are fully vaccinated with MMR and COVID?”.

In accordance with an embodiment, at 2, the application 1120 can, after processing the natural language of the query within the request, communicate to processed query to a vector database 1121. The vector database can employ a semantic search (e.g., a one-stage sematic search) on SQL tables/descriptions. At 3, the vector database can then return tables, or indications thereof, relevant to the query. These relevant tables are provided as context for the received query.

In accordance with an embodiment, at 4, the application can, after receiving the relevant tables from vector database, query a large language model (LLM) 1122 with the query (e.g., the actual query or the processed natural language thereof) as well as the context provided by the vector database. The LLM can, at 5, return a generated query (e.g., in the form of a SQL output) to the application. The generated query can be based upon the query, as well as the context provided by the vector database.

In accordance with an embodiment, at 6, the application can run the generated query against a datastore, such as enterprise data 103, which can comprise customer applications, database(s), and/or an autonomous data warehouse (ADW) 1101. The application can receive from the datastore, once the generated query has run, results of the generated query at 7. In the depicted embodiment, the datastore comprising the enterprise data 103 is separate from the could infrastructure/data analytics environment. Such can be the case when, for example, the user/client maintains an enterprise datastore separately from the application.

In accordance with an embodiment, at 8, the application can return the results of the generated query run against the datastore to the client device. Such return can comprise, for example, raw textual results, generated (e.g., by the Application) text results, raw graphical results, and/or generated (e.g., by the Application) graphical results. Such return can additionally comprise other data and/or media retrieved from the datastore by running the generated query, such as audio data, pictorial data, graphical data . . . etc.

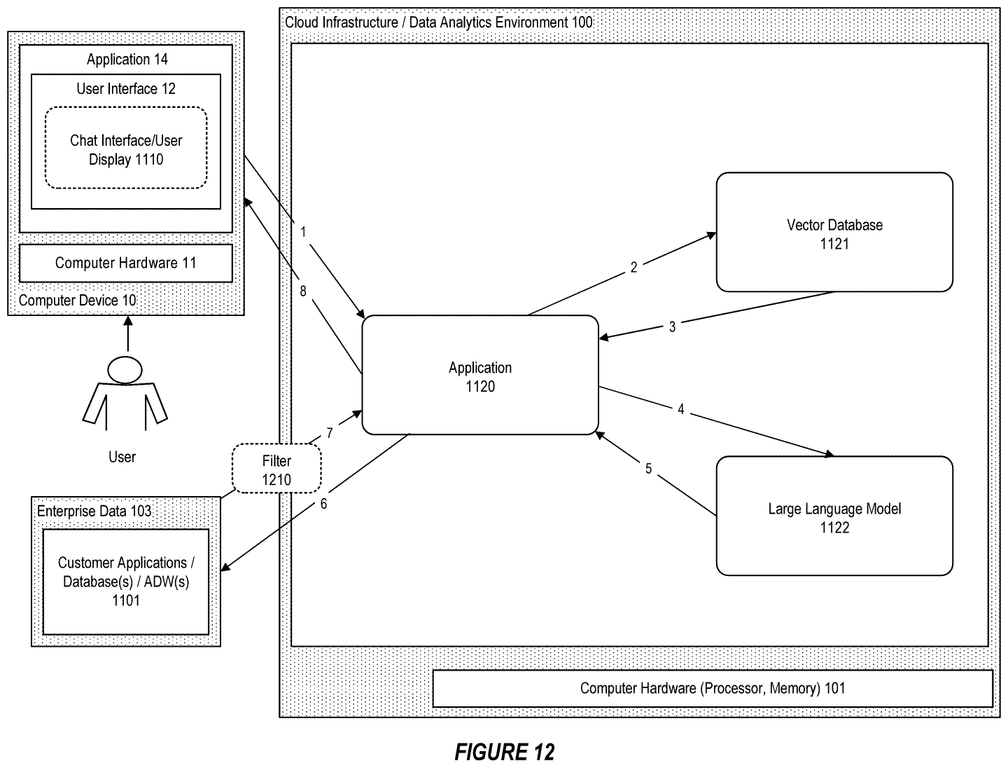

FIG. 12 illustrates a system for providing hi-query AI for use with a data analytics environment, in accordance with an embodiment.

In accordance with an embodiment, a cloud infrastructure or data analytics environment 100 can operate on a cloud computing infrastructure 101 comprising hardware (e.g., processor, memory), software resources, and one or more cloud interfaces or other application program interfaces (API) that provide access to the shared cloud resources via one or more load balancers.

In accordance with an embodiment, a client device, such as, for example, a computing device 10 having a device hardware 11 (e.g., processor, memory), application 14 and user interface 12, such as a graphical user interface, can enable an administrator other user to communicate with the cloud infrastructure environment via a network such as, for example, a wide area network, local area network, or the Internet, to create, utilize or update cloud services.

In accordance with an embodiment, an application 1120 can be provided within the cloud infrastructure/data analytics environment 100. The application, which when accessed by, for example, the computer device 100 can provide at the user interface, a chat or text interface 1110 which a user can interact with and/or provide inputs or receive outputs from.

In accordance with an embodiment, the application, at 1, can receive a request for a query from the computer device. The request can comprise, for example, metrics sought by a user of the client device, and/or a measure. The request can comprise a natural language request. The system can take a user's natural language question and run a semantic search to discern the query's intent and find tables relevant to the question. Example requests can comprise, “What are the top 5 most common appointment types?”, or “What percentage of patients under 5 are fully vaccinated with MMR and COVID?”.

In accordance with an embodiment, at 2, the application 1120 can, after processing the natural language of the query within the request, communicate to processed query to a vector database 1121. The vector database can employ a semantic search (e.g., a one-stage sematic search) on SQL tables/descriptions. At 3, the vector database can then return tables, or indications thereof, relevant to the query. These relevant tables are provided as context for the received query.

In accordance with an embodiment, at 4, the application can, after receiving the relevant tables from vector database, query a large language model (LLM) 1122 with the query (e.g., the actual query or the processed natural language thereof) as well as the context provided by the vector database. The LLM can, at 5, return a generated query (e.g., in the form of a SQL output) to the application. The generated query can be based upon the query, as well as the context provided by the vector database.

In accordance with an embodiment, at 6, the application can run the generated query against a datastore, such as enterprise data 103, which can comprise customer applications, database(s), and/or an autonomous data warehouse (ADW) 1101. The application can receive from the datastore, once the generated query has run, results of the generated query at 7. In the depicted embodiment, the datastore comprising the enterprise data 103 is separate from the could infrastructure/data analytics environment. Such can be the case when, for example, the user/client maintains an enterprise datastore separately from the application.

In accordance with an embodiment, the Application 1120 can deploy or utilize a filter 1210 when receiving the results from the datastore at 7. This filter can be a pre-existing filter, or it can be written by the Application. Such a filter 1210 can be utilized when, for example, the results returned from the datastore contain personal identifying information (PII), protected medical information, and/or other sensitive information. Such a filter 1210 can be, for example, based upon a security level, and/or level of clearance of a user utilizing the client device.

In accordance with an embodiment, at 8, the application can return the results of the generated query run against the datastore to the client device. Such return can comprise, for example, raw textual results, generated (e.g., by the Application) text results, raw graphical results, and/or generated (e.g., by the Application) graphical results. Such return can additionally comprise other data and/or media retrieved from the datastore by running the generated query, such as audio data, pictorial data, graphical data . . . etc.

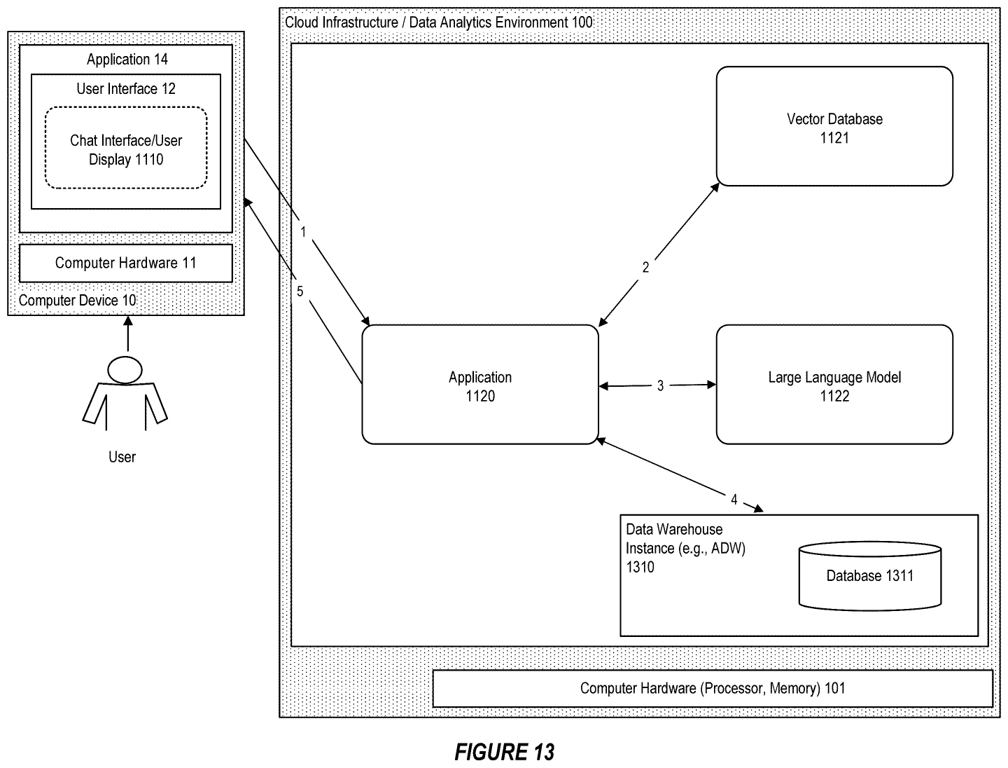

FIG. 13 illustrates a system for providing hi-query AI for use with a data analytics environment, in accordance with an embodiment.

In accordance with an embodiment, a cloud infrastructure or data analytics environment 100 can operate on a cloud computing infrastructure 101 comprising hardware (e.g., processor, memory), software resources, and one or more cloud interfaces or other application program interfaces (API) that provide access to the shared cloud resources via one or more load balancers.

In accordance with an embodiment, a client device, such as, for example, a computing device 10 having a device hardware 11 (e.g., processor, memory), application 14 and user interface 12, such as a graphical user interface, can enable an administrator other user to communicate with the cloud infrastructure environment via a network such as, for example, a wide area network, local area network, or the Internet, to create, utilize or update cloud services.

In accordance with an embodiment, an application 1120 can be provided within the cloud infrastructure/data analytics environment 100. The application, which when accessed by, for example, the computer device 100 can provide at the user interface, a chat or text interface 1110 which a user can interact with and/or provide inputs or receive outputs from.

In accordance with an embodiment, the application, at 1, can receive a request for a query from the computer device. The request can comprise, for example, metrics sought by a user of the client device, and/or a measure. The request can comprise a natural language request. The system can take a user's natural language question and run a semantic search to discern the query's intent and find tables relevant to the question. Example requests can comprise, “What are the top 5 most common appointment types?”, or “What percentage of patients under 5 are fully vaccinated with MMR and COVID?”.

In accordance with an embodiment, at 2, the application 1120 can, after processing the natural language of the query within the request, communicate to processed query to a vector database 1121. The vector database can employ a semantic search (e.g., a one-stage sematic search) on SQL tables/descriptions. The vector database can then return tables, or indications thereof, relevant to the query. These relevant tables are provided as context for the received query.

In accordance with an embodiment, at 3, the application can, after receiving the relevant tables from vector database, query a large language model (LLM) 1122 with the query (e.g., the actual query or the processed natural language thereof) as well as the context provided by the vector database. The LLM can return a generated query (e.g., in the form of a SQL output) to the application. The generated query can be based upon the query, as well as the context provided by the vector database.

In accordance with an embodiment, at 4, the application can run the generated query against a datastore, such as data warehouse instance 1310, which can comprise customer applications, database(s), and/or an autonomous data warehouse, at which a database 1311 is provided. The application can receive from the datastore, once the generated query has run, results of the generated query. In the depicted embodiment, the datastore comprising the data warehouse instance 1310 provisioned as part of the could infrastructure/data analytics environment. Such can be the case when, for example, the user/client maintains a data warehouse instance together with the services provided by the cloud infrastructure/data analytics environment.

In accordance with an embodiment, at 5, the application can return the results of the generated query run against the datastore to the client device. Such return can comprise, for example, raw textual results, generated (e.g., by the Application) text results, raw graphical results, and/or generated (e.g., by the Application) graphical results. Such return can additionally comprise other data and/or media retrieved from the datastore by running the generated query, such as audio data, pictorial data, graphical data . . . etc.

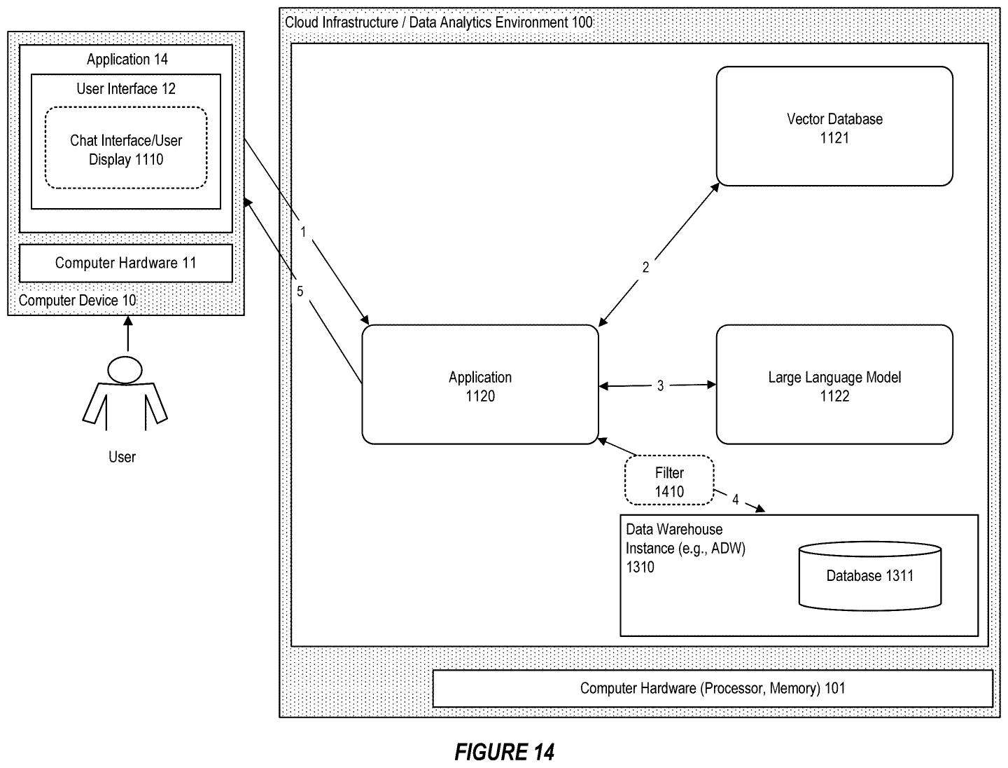

FIG. 14 illustrates a system for providing hi-query AI for use with a data analytics environment, in accordance with an embodiment.

In accordance with an embodiment, a cloud infrastructure or data analytics environment 100 can operate on a cloud computing infrastructure 101 comprising hardware (e.g., processor, memory), software resources, and one or more cloud interfaces or other application program interfaces (API) that provide access to the shared cloud resources via one or more load balancers.

In accordance with an embodiment, a client device, such as, for example, a computing device 10 having a device hardware 11 (e.g., processor, memory), application 14 and user interface 12, such as a graphical user interface, can enable an administrator other user to communicate with the cloud infrastructure environment via a network such as, for example, a wide area network, local area network, or the Internet, to create, utilize or update cloud services.

In accordance with an embodiment, an application 1120 can be provided within the cloud infrastructure/data analytics environment 100. The application, which when accessed by, for example, the computer device 100 can provide at the user interface, a chat or text interface 1110 which a user can interact with and/or provide inputs or receive outputs from.

In accordance with an embodiment, the application, at 1, can receive a request for a query from the computer device. The request can comprise, for example, metrics sought by a user of the client device, and/or a measure. The request can comprise a natural language request. The system can take a user's natural language question and run a semantic search to discern the query's intent and find tables relevant to the question. Example requests can comprise, “What are the top 5 most common appointment types?”, or “What percentage of patients under 5 are fully vaccinated with MMR and COVID?”.

In accordance with an embodiment, at 2, the application 1120 can, after processing the natural language of the query within the request, communicate to processed query to a vector database 1121. The vector database can employ a semantic search (e.g., a one-stage sematic search) on SQL tables/descriptions. The vector database can then return tables, or indications thereof, relevant to the query. These relevant tables are provided as context for the received query.

In accordance with an embodiment, at 3, the application can, after receiving the relevant tables from vector database, query a large language model (LLM) 1122 with the query (e.g., the actual query or the processed natural language thereof) as well as the context provided by the vector database. The LLM can return a generated query (e.g., in the form of a SQL output) to the application. The generated query can be based upon the query, as well as the context provided by the vector database.

In accordance with an embodiment, at 4, the application can run the generated query against a datastore, such as data warehouse instance 1310, which can comprise customer applications, database(s), and/or an autonomous data warehouse, at which a database 1311 is provided. The application can receive from the datastore, once the generated query has run, results of the generated query. In the depicted embodiment, the datastore comprising the data warehouse instance 1310 provisioned as part of the could infrastructure/data analytics environment. Such can be the case when, for example, the user/client maintains a data warehouse instance together with the services provided by the cloud infrastructure/data analytics environment.

In accordance with an embodiment, the Application 1120 can deploy or utilize a filter 1410 when receiving the results from the datastore. This filter can be a pre-existing filter, or it can be written by the Application. Such a filter 1410 can be utilized when, for example, the results returned from the datastore contain personal identifying information (PII), protected medical information, and/or other sensitive information. Such a filter 1410 can be, for example, based upon a security level, and/or level of clearance of a user utilizing the client device.

In accordance with an embodiment, at 5, the application can return the results of the generated query run against the datastore to the client device. Such return can comprise, for example, raw textual results, generated (e.g., by the Application) text results, raw graphical results, and/or generated (e.g., by the Application) graphical results. Such return can additionally comprise other data and/or media retrieved from the datastore by running the generated query, such as audio data, pictorial data, graphical data . . . etc.

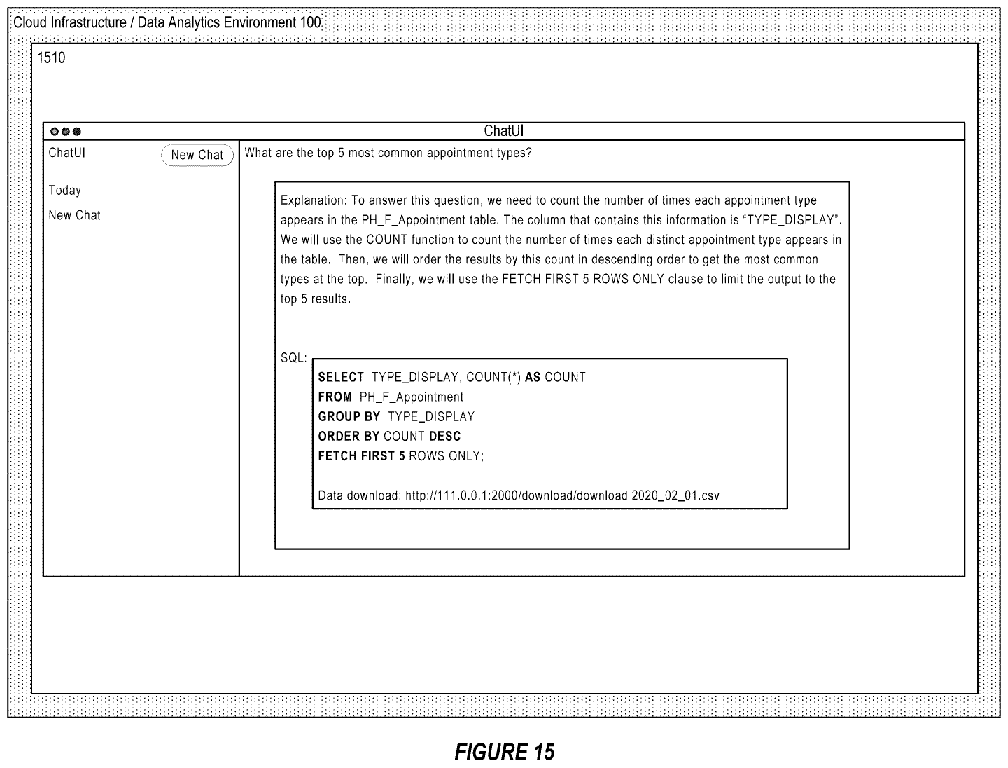

FIG. 15 illustrates a screenshot produced by a system for use with a data analytics environment for providing hi-query AI for use with a data analytics environment, in accordance with an embodiment.

In accordance with an embodiment, as shown, the screenshot 1510 shows a SQL response to a natural language query “What are the top 5 most common appointment types?”. The response additionally includes an explanation as well as a link to an associated data download.

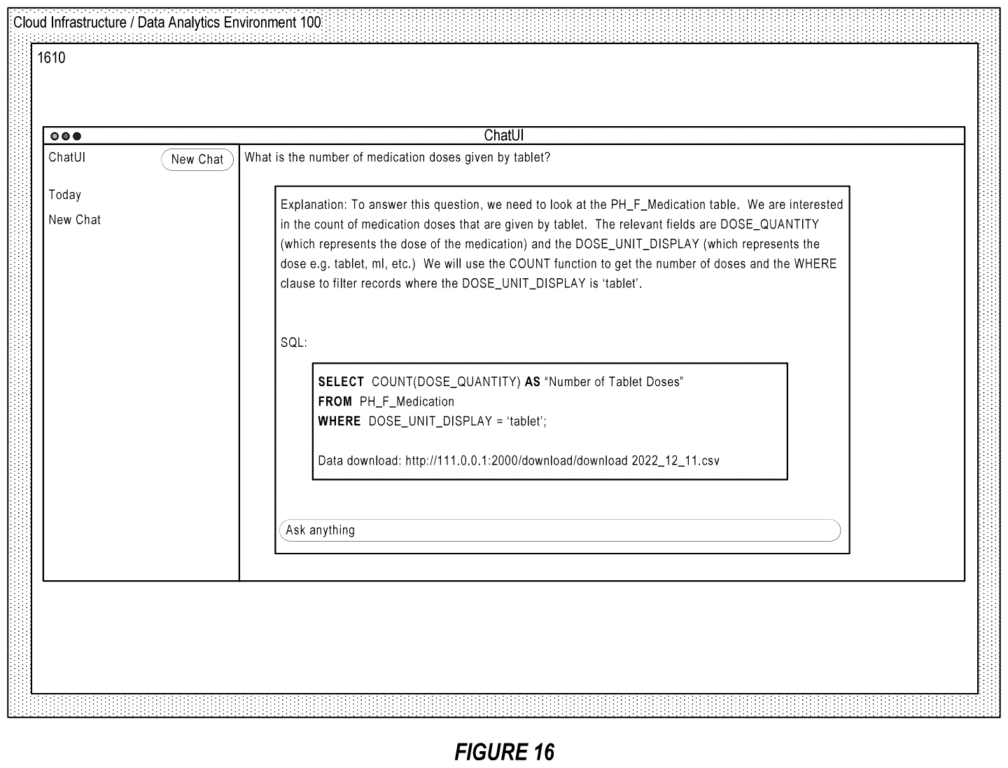

FIG. 16 illustrates a screenshot produced by a system for use with a data analytics environment for providing hi-query AI for use with a data analytics environment, in accordance with an embodiment.

In accordance with an embodiment, as shown, the screenshot 1610 shows a SQL response to a natural language query “What is the number of medication doses given by tablet?”. The response additionally includes an explanation as well as a link to an associated data download.

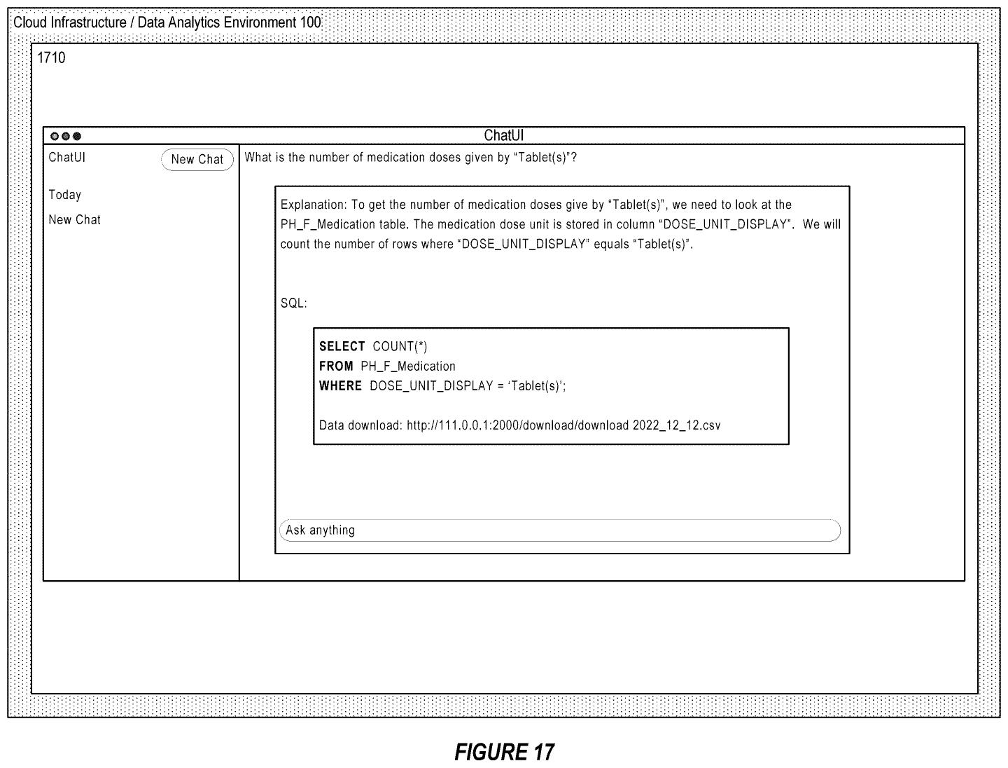

FIG. 17 illustrates a screenshot produced by a system for use with a data analytics environment for providing hi-query AI for use with a data analytics environment, in accordance with an embodiment.

In accordance with an embodiment, as shown, the screenshot shows a SQL response to a natural language query “What is the number of medication doses given by “Tablet(s)?”. The response additionally includes an explanation as well as a link to an associated data download.

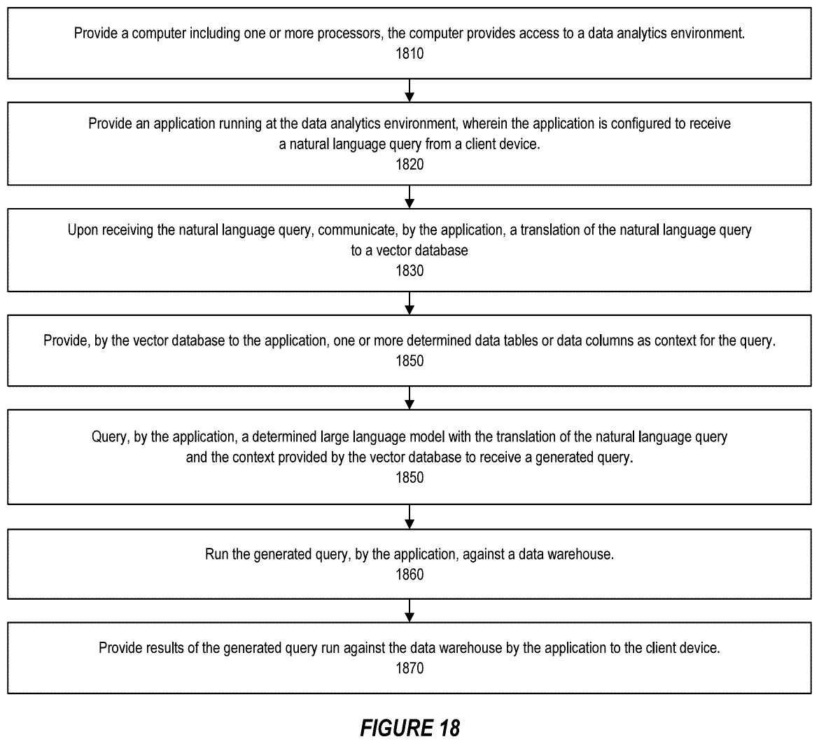

FIG. 18 illustrates a flowchart of a method for use with a data analytics environment to provide hi-query AI for use with a data analytics environment, in accordance with an embodiment.

In accordance with an embodiment, at step 1810, the method can provide a computer including one or more processors, the computer provides access to a data analytics environment.

In accordance with an embodiment, at step 1820, the method can provide an application running at the data analytics environment, wherein the application is configured to receive a natural language query from a client device.

In accordance with an embodiment, at step 1830, the method can, upon receiving the natural language query, communicate, by the application, a translation of the natural language query to a vector database.

In accordance with an embodiment, at step 1840, the method can provide, by the vector database to the application, one or more determined data tables or data columns as context for the query.

In accordance with an embodiment, at step 1850, the method can query, by the application, a determined large language model with the translation of the natural language query and the context provided by the vector database to receive a generated query.

In accordance with an embodiment, at step 1860, the method can run the generated query, by the application, against a data warehouse.

In accordance with an embodiment, at step 1870, the method can provide results of the generated query run against the data warehouse by the application to the client device.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art. For example, although several of the examples provided herein illustrate use with cloud environments such as Oracle Analytics Cloud; in accordance with various embodiments, the systems and methods described herein can be used with other types of enterprise software applications, cloud environments, cloud services, cloud computing, or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for use with a data analytics environment for providing hi-query AI for use with a data analytics environment, comprising:
a computer including one or more processors, that provides access to a data analytics environment; and
an application running at the data analytics environment, wherein the application is configured to receive a natural language query from a client device;
wherein the application, upon receiving the natural language query, communicates a translation of the natural language query to a vector database;
wherein the vector database provides to the application one or more determined data tables or data columns as context for the query;
wherein the application queries a determined large language model with the translation of the natural language query and the context provided by the vector database to receive a generated query;
wherein the generated query is run, by the application, against a data warehouse; and
wherein results of the generated query run against the data warehouse are provided by the application to the client device.

2. The system of claim 1,
wherein the application comprises a natural language processor which translates the received natural language query to generate the translation of the natural language query.

3. The system of claim 1,
wherein a filter is provided which filters the results of the generated query run against the data warehouse prior to returning the results to the application.

4. The system of claim 3,
wherein the filter is configured by the application to filter personal identifying information and/or medical information.

5. The system of claim 1,
wherein the data warehouse comprises an autonomous data warehouse associated.

6. The system of claim 1,
wherein the natural language query comprises an instruction to generate a measure.

7. The system of claim 6,
wherein the results returned from the query run against the data warehouse comprise a generated measure.

8. A method for use with a data analytics environment for providing hi-query AI for use with a data analytics environment, comprising:
providing a computer including one or more processors, the computer provides access to a data analytics environment;
providing an application running at the data analytics environment, wherein the application is configured to receive a natural language query from a client device;
upon receiving the natural language query, communicating, by the application, a translation of the natural language query to a vector database;
providing, by the vector database to the application, one or more determined data tables or data columns as context for the query;
querying, by the application, a determined large language model with the translation of the natural language query and the context provided by the vector database to receive a generated query;
running the generated query, by the application, against a data warehouse; and
providing results of the generated query run against the data warehouse by the application to the client device.

9. The method of claim 8,
wherein the application comprises a natural language processor which translates the received natural language query to generate the translation of the natural language query.

10. The method of claim 8,
wherein a filter is provided which filters the results of the generated query run against the data warehouse prior to returning the results to the application.

11. The method of claim 10,
wherein the filter is configured by the application to filter personal identifying information and/or medical information.

12. The method of claim 8,
wherein the data warehouse comprises an autonomous data warehouse associated.

13. The method of claim 8,
wherein the natural language query comprises an instruction to generate a measure.

14. The method of claim 13,
wherein the results returned from the query run against the data warehouse comprise a generated measure.

15. A non-transitory computer readable storage medium having instructions thereon for use with a data analytics environment for providing hi-query AI for use with a data analytics environment, which when run and executed cause a computer to perform steps comprising:
providing, by the computer including one or more processors, access to a data analytics environment;
providing an application running at the data analytics environment, wherein the application is configured to receive a natural language query from a client device;
upon receiving the natural language query, communicating, by the application, a translation of the natural language query to a vector database;
providing, by the vector database to the application, one or more determined data tables or data columns as context for the query;
querying, by the application, a determined large language model with the translation of the natural language query and the context provided by the vector database to receive a generated query;
running the generated query, by the application, against a data warehouse; and
providing results of the generated query run against the data warehouse by the application to the client device.

16. The non-transitory computer readable storage medium of claim 15,
wherein the application comprises a natural language processor which translates the received natural language query to generate the translation of the natural language query.

17. The non-transitory computer readable storage medium of claim 15,
wherein a filter is provided which filters the results of the generated query run against the data warehouse prior to returning the results to the application.

18. The non-transitory computer readable storage medium of claim 17,
wherein the filter is configured by the application to filter personal identifying information and/or medical information.

19. The non-transitory computer readable storage medium of claim 15,
wherein the data warehouse comprises an autonomous data warehouse associated.

20. The non-transitory computer readable storage medium of claim 15,
wherein the natural language query comprises an instruction to generate a measure; and
wherein the results returned from the query run against the data warehouse comprise a generated measure.
